(19) United States
(12) Patent Application Publication
(10) Pub. No.: US 2019/0238931 A1
(43) Pub. Date: Aug. 1, 2019

(54) SIGNAL RECEIVING APPARATUS CONFORMING TO DIGITAL VIDEO BROADCASTING STANDARD AND SIGNAL PROCESSING METHOD THEREOF

(71) Applicant: MStar Semiconductor, Inc., Hsinchu Hsien (TW)

(72) Inventor: Yu-Shen CHOU, Hsinchu Hsien (TW)

(21) Appl. No.: 15/957,080

(22) Filed: Apr. 19, 2018

(30) Foreign Application Priority Data
Feb. 1, 2018 (TW) 107103617

(51) Int. Cl. H04N 21/44; H04N 21/4402; H04N 21/442; H04N 21/24

(52) U.S. Cl. CPC H04N 21/44004; H04N 21/2401; H04N 21/44209; H04N 21/4402

(57) ABSTRACT

A signal receiving apparatus is provided. A time de-interleaver performs time de-interleaving on multiple interleaved video frames to generate a time de-interleaving result, and generates a counting request upon identifying a starting point of an interleaved video frame under verification. A signal processing circuit performs signal processing having an average delay on the time de-interleaving result to generate a signal processing result. A de-jittering buffer generates an output request upon obtaining an original time-to-output (TTO) of the interleaved video frame under verification, and transforms the signal processing result to a transport stream. A verification circuit generates a counting result according to the counting request and the output request, and determines whether the TTO satisfies a predetermined condition according to the counting result and the average delay. If the TTO under verification does not satisfy the predetermined condition, a corrected TTO under verification is generated and verified.

This application claims the benefit of Taiwan application Serial No. 107103617, filed Feb. 1, 2018, the subject matter of which is incorporated herein by reference.

### BACKGROUND OF THE INVENTION

### Field of the Invention

The invention relates to Digital Video Broadcasting (DVB), and more particularly to a de-jitter buffer in a DVB receiving end.

### Description of the Related Art

The development of digital video broadcasting has gradually matured with the progressing of communication technologies. The Digital Video Broadcasting (DVB) standard is one mainstream digital video broadcasting standard in African and Asian regions. FIG. 1 shows a brief function block diagram of a DVB receiving end, which includes a tuner 101, an analog-to-digital converter (ADC) 102, a front-end circuit 103, a demodulation circuit 104, an equalizer 105, a de-interleaving and forward error correction (FEC) circuit 106, a de-jitter buffer 107, a source decoder 108 and a display 109.

The de-jitter buffer 107 serves a main purposes of buffering data sequentially outputted from the de-interleaving and FEC circuit 106, combines the data into a transport stream, and transmits the transport stream at an appropriate speed to the source decoder 108. If the de-jitter circuit 107 outputs the transport stream without waiting for a period of time after receiving a first set of data, subsequent data in the transport stream may not be ready yet for output after the first set of data because the speed at which the de-interleaving and FEC circuit 106 stores the data into the de-jitter buffer 107 is not fast enough. Such issue is referred to as underflow. Conversely, if the de-jitter buffer 107 starts outputting the transport stream too slowly, storage space in the de-jitter buffer 107 for accommodating the data stored thereinto by the de-interleaving and FEC circuit 106, causing an issue of overflow.

According to the specification of the DVB standard, a transmitting end provides a time-to-output (TTO) parameter to the de-jitter buffer 107 at the receiving end for each interleaved video frame, wherein the TTO parameter indicates a starting time point for the de-jitter buffer 107 to output the transport stream corresponding to the interleaved video frame.

However, in actual conditions, it is a common problem that a transmitting end does not provide a reasonable TTO parameter to a receiving end. For example, some transmitting ends sets TTO parameters of all interleaved video frames to zero. If a receiving end uses these TTO parameters without checking, the abovementioned issue of underflow may be encountered, severely affecting the normal operation of the receiving end.

### SUMMARY OF THE INVENTION

To solve the above issues, the present invention provides a signal receiving apparatus and a signal processing method.

A signal receiving apparatus is provided according to an embodiment of the present invention. The signal receiving apparatus receives a video signal provided by a Digital Video Broadcasting (DVB) transmitting end, wherein the video signal corresponds to multiple interleaved video frames. The signal receiving apparatus includes a time de-interleaver, a signal processing circuit, a verification circuit, a de-jitter buffer, a correction circuit and a setting circuit. The time de-interleaving circuit performs time de-interleaving on the multiple interleaved video frames to generate a time de-interleaving result, and generates a counting request upon identifying an interleaved video frame under verification. The signal processing circuit performs signal processing on the time de-interleaving result to generate a signal processing result. The signal processing has an average delay. The de-jitter buffer obtains an original time-to-output (TTO) of the interleaved video frame under verification from the signal processing result, accordingly generates an output request, and transforms the signal processing request to a transport stream. The verification circuit generates a counting result according to the counting request and the output request, and determines, according to the counting result and the average delay, whether a TTO under verification of the interleaved video frame under verification satisfies a predetermined condition. If the TTO under verification does not satisfy the predetermined condition, the correction circuit generates a corrected TTO under verification, and requests the verification circuit to verify whether the corrected TTO under verification satisfies the predetermined condition. If the TTO under verification satisfies the predetermined condition, the setting circuit sets, according to the TTO under verification, a time to output the transport stream for the de-jitter buffer.

A signal processing method applied to a Digital Video Broadcasting (DVB) receiving end is provided according to another embodiment of the present invention. The method includes: a) receiving a video signal provided by the DVB receiving end, wherein the video signal corresponds to multiple interleaved video frames; b) performing time de-interleaving on the multiple interleaved video frames to generate a time de-interleaving result, and generating an output request upon identifying a starting point of an interleaved video frame under verification; c) performing signal processing on the time de-interleaving result to generate a signal processing result, wherein the signal processing has an average delay; d) obtaining an original time-to-output (TTO) of the interleaved video frame under verification from the signal processing result, and accordingly generating an output request; e) transforming the signal processing result to a transport stream; f) generating a counting result according to the counting request and the output request, and determining whether a TTO under verification of the interleaved video frame under verification satisfies a predetermined condition according to the timing result and the average delay; g) if the TTO under verification does not satisfy the predetermined condition, generating a corrected TTO under verification, and verifying whether the corrected TTO under verification satisfies the predetermined condition; and h) if the TTO under verification satisfies the predetermined condition, setting, according to the TTO under verification, a time to output the transport stream.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 (prior art) is a brief function block diagram of a Digital Video Broadcasting (DVB) receiving end;

FIG. 2 is a function block diagram of a signal receiving apparatus according to an embodiment of the present invention;

FIG. 3 is a diagram illustrating connections of a de-interleaving and forward error check (FEC) circuit, a de-jitter buffer, a verification circuit, a correction circuit and a setting circuit according to an embodiment of the present invention; and

FIG. 4 is a flowchart of a signal processing method according to an embodiment of the present invention.

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

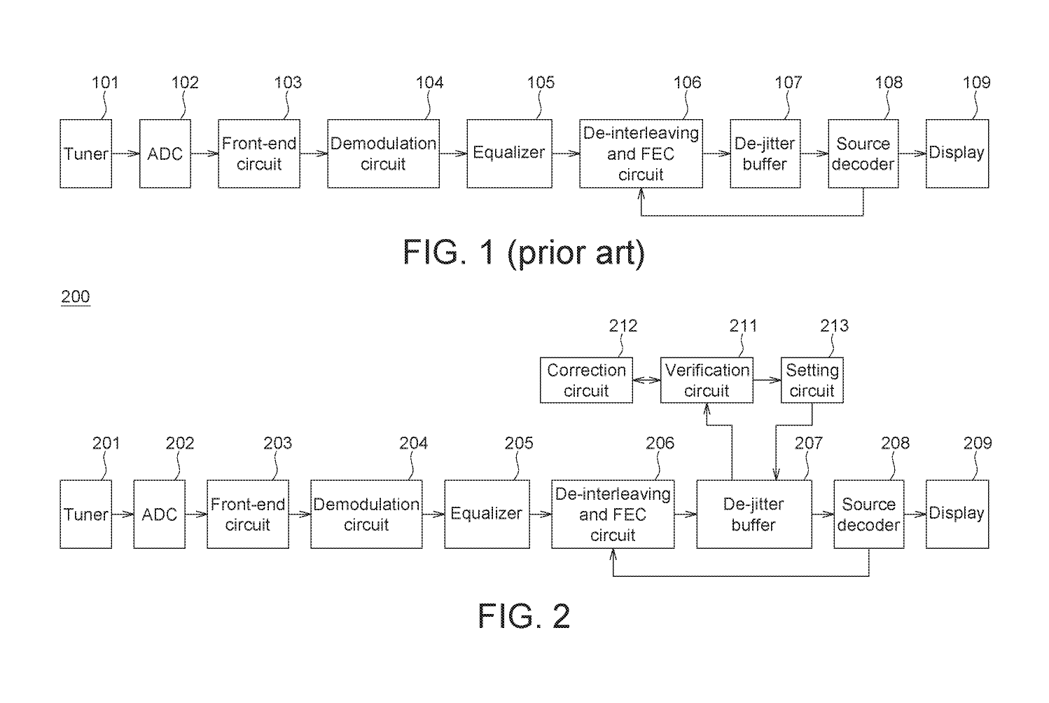

FIG. 2 shows a function block diagram of a signal receiving apparatus conforming to the Digital Video Broadcasting (DVB) standard according to an embodiment of the present invention. A signal receiving apparatus 200 includes a tuner 201, an analog-to-digital converter (ADC) 202, a front-end circuit 203, a demodulation circuit 104, an equalizer 205, a de-interleaving and forward error check (FEC) circuit 206, a de-jitter buffer 207, a source decoder 208, a display 209, a verification circuit 211, a correction circuit 212, and a setting circuit 213. Comparing FIG. 1 and FIG. 2, it is seen that the signal receiving apparatus 200 has a major characteristic of being provided with the verification circuit 211, the correction circuit 212 and the setting circuit 213 that coordinate with the de-jitter buffer 207.

As previously described, for each interleaved video frame, a transmitting end provides a time-to-output (TTO) parameter for reference of the de-jitter buffer 207. In practice, a transmitting end may provide unreliable TTO parameters for quite a few consecutive interleaved video frames. It is known that, if one TTO parameter acquired by the de-jitter buffer 207 is deemed unreasonable, following TTO parameters of other subsequent interleaved video frames are much likely unreasonable. Thus, in the signal receiving apparatus 200, the verification circuit 211 first verifies a TTO parameter (to be referred to as an original TTO parameter (TTO_TX)) that a transmitting end provides for one certain interleaved video frame to determine whether to initiate a subsequent correction procedure. More specifically, if the verification circuit 211 determines that the original time to output TTO_TX satisfies a predetermined condition, the verification circuit 211 requests the setting circuit 213 to set, according to the original time to output TTO_TX, a starting time point at which the de-jitter buffer 207 outputs the transport stream. Conversely, if the verification circuit 211 determines that the original TTO TTO_TX does not satisfy the predetermined condition, the correction circuit 212 generates a corrected TTO, and requests the verification circuit 211 to again perform verification to determine whether the corrected TTO satisfies the predetermined condition. Only when the corrected TTO satisfying the predetermined condition has been successfully identified, the setting circuit 213 sets, according to the corrected TTO, a starting time point for outputting the transport stream for the de-jitter buffer 207.

The predetermined condition used by the verification circuit 211, and implementation details of the verification circuit 211, the correction circuit 212 and the setting circuit 213 are given in the embodiments below.

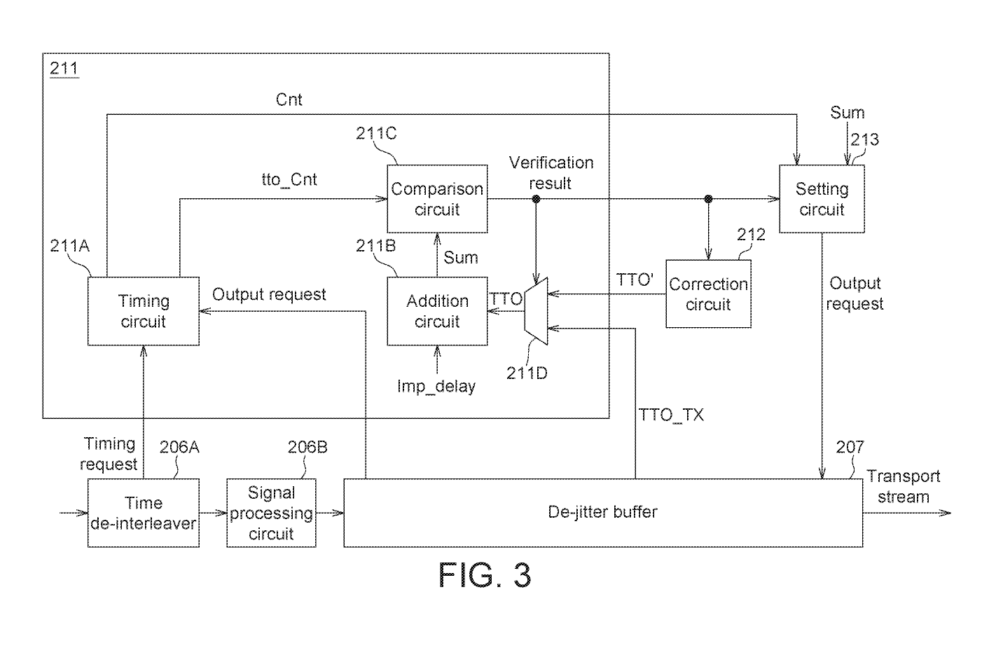

FIG. 3 shows connections of the de-interleaving and FEC circuit 206, the de-jitter buffer 207, the verification circuit 211, the correction circuit 212 and the setting circuit 213 according to an embodiment of the present invention. In FIG. 3, two function blocks in the de-interleaving and FEC circuit 206 are depicted—a time de-interleaver 206A and a signal processing circuit 206B. In practice, in the de-interleaving and FEC circuit 206, the time de-interleaver 206A is usually coupled after a frequency de-interleaver, and the signal processing circuit 206B refers to circuits coupled between the time de-interleaver 206A and the de-jitter circuit 207 in the signal receiving apparatus 200. The signal processing circuit 206B may include, for example but not limited to, a cell de-interleaver, a cyclic delay removal circuit, a soft decision circuit, a bit de-interleaver, a low density parity check (LDPC) decoder, a BCH decoder, or a baseband descrambling circuit.

The time spending on signal processing processes in the signal processing circuit 206B contribute an implementation delay, which is also referred to as a transmission latency. An average (to be referred to as an average delay imp_delay) of the implementation delay may be generated through simulation calculations or actual measurements, and is pre-stored in a memory (not shown) of the signal receiving apparatus 200. It should be noted that, the value of the average delay imp_delay may differ as a signal format (e.g., an encoding mode) changes; average delays imp_delay corresponding to multiple different signal formats may be pre-stored in the signal receiving apparatus 200 to serve as reference information for the verification circuit 211.

In this embodiment, the verification circuit 211 includes a timing circuit 211A, an addition circuit 211B, a comparison circuit 211C and a multiplexer 211D. The timing circuit 211A counts a working time length Cnt. As shown in FIG. 3, the timing circuit 211A receives a counting request from the time de-interleaver 206A. More specifically, upon identifying a starting point of the interleaved video frame under verification, the time de-interleaver 206A enables the timing circuit 211A to start counting. On the other hand, the de-jitter buffer 207 transmits a output request to the timing circuit 211A when it acquires the original time to output TTO_TX of the interleaved video frame from parsing the input signal thereof. After receiving the output request, the timing circuit 211A uses the currently accumulated working time length Cnt as a counting result tto_Cnt, and transmits the counting result tto_Cnt to the comparison circuit 211C. The counting result tto_Cnt may be a length of a working time length spent by the time de-interleaver 206A, the signal processing circuit 206B and the de-jitter buffer 207 to process the interleaved video frame under verification. The interleaved video frame under verification processed by the verification circuit 211 at an initial verification is referred as an initial interleaved video frame, and the counting result tto_Cnt generated when the counting circuit 211A initially generates for the initial interleaved video frame is represented as tto_Ctn_0.

It should be noted that, details of how the timing de-interleaver 206A identifies a starting point of an interleaved video frame and how the de-jitter buffer 207 acquires the original TTO TTO_TX are generally known to one person skilled in the art, and shall be omitted herein. On the other hand, although the output request is received to generate a counting result tto_Cnt, the counting circuit 211A continues counting. The working time length Cnt accumulated by the counting circuit 211A is provided to the setting circuit 213 for further use, with associated details to be given shortly.

As previously described, the average delay imp_delay contributed by the signal processing circuit 206B is known in advance. The addition circuit 211B receives the average delay imp_delay, and calculates a summation result Sum of the average delay imp_delay and a TTO under verification. As shown in FIG. 3, the multiplexer 211D receives the original TTO TTO_TX acquired by the de-jitter buffer 207 and the corrected TTO TTO′ generated by the correction circuit 212, and selects one from the two as the TTO under verification that is to be sent to the addition circuit 211B. When the verification circuit 211 initially performs the verification, the TTO under verification is the original TTO TTO_TX of the initial interleaved video frame, and the addition result Sum calculated by the addition circuit 211B for the initial interleaved video frame is represented as Sum_0. In other words, the addition result Sum_0 is a sum of the original TTO TTO_TX and the average delay imp_delay.

In this embodiment, the predetermined condition used by the verification circuit 211 is set as “the addition result Sum of the average delay imp_delay and the TTO under verification needs to be greater than the counting result tto_Cnt”. Thus, the comparison circuit 211 compares the values of the addition result Sum with the counting result tto_Cnt. More specifically, the transmitting end usually sets the original TTO TTO_TX according to the time spent in an encoding process; however, the time spent in a decoding procedure at a receiving end is usually longer than the time spent in the encoding process at the transmitting end. For example, it costs some time for trial-and-errors in signal processing of the signal processing circuit 206B that is not within the period covered by the original TTO TTO_TX, and so the average delay imp_delay is taken into account. With the average delay imp_delay added, a reasonable/reliable original TTO TTO_TX allows the condition “the addition result Sum_0 is greater than the counting result tto_Cnt_0” to be met.

A scenario where “the addition result Sum_0 is greater than the counting result tto_Cnt_0” is first discussed. When the verification result outputted by the comparison circuit 211C indicates that the original TTO TTO_TX satisfies the above predetermined condition, the correction circuit 212 is idling, and the setting circuit 213 sets, according to the original TTO TTO_TX, a starting time point of outputting the transport stream for the de-jitter buffer 207. In this case, the time to output of the de-jitter buffer 207 is set to be equal to the addition result Sum_0 of the original TTO TTO_TX and the average delay imp_delay. As shown in FIG. 3, the working time length Cnt calculated by the counting circuit 211A and the addition result Sum_0 generated by the addition circuit 211B are both provided to the setting circuit 213. When the working time length Cnt reaches the addition result Sum_0, the setting circuit 213 sends an output request to request the de-jitter buffer 207 to start outputting the transport stream corresponding to the initial interleaved video frame.

In practice, for two successive interleaved video frames time having same timing interleaving depth and encoding mode, the time to output of these two interleaved video frames do not differ much. If the time interleaving depth and encoding mode of multiple successive interleaved video frames are the same, it can be inferred that the TTOs of these interleaved video frames are close to one another. Thus, when it is determined that the original TTO TTO_TX of the initial interleaved video frame is reliable, it is not necessary for the verification circuit 211 to continue verifying the original TTO of the subsequent interleaved video frames one after another. More specifically, the setting circuit 213 can set, on the basis of the original TTO TTO_TX of the initial interleaved video frame, the same TTO for the following successive interleaved video frames, for the de-jitter buffer 207 to output the corresponding transport streams.

It should be noted that, the time point set by the setting circuit 213 for the de-jitter buffer 207 to output the transport stream may not be exactly equal to the addition result Sum_0. For example, the decoding time lengths of the interleaved video frames may slightly vary. Thus, the time the de-jitter buffer 207 outputs the transport stream may be slightly greater than the addition result Sum_0 so as to cover the variances in the decoding time lengths of the subsequent interleaved video frames. Setting the addition result Sum_0 greater than the counting result tto_Cnt_0 as the time point at which the setting circuit 213 generates the output request ensures the de-jitter buffer 207 from being underflow. On the other hand, an upper limit of the time to output that the setting circuit 213 generates does not cause overflow of the de-jitter buffer 207. One person skilled in the art can understand that, given that the time to output that the setting circuit 213 generates is set within an appropriate range, the de-jitter buffer 207 will not suffer from underflow or overflow. That is to say, the time point at which the setting circuit 213 generates the output request is flexible to a certain extent.

A scenario where “the addition result Sum_0 is smaller than or equal to the counting result tto_Cnt_0” is discussed below. When the verification result outputted from the comparing circuit 211C indicates that the original TTO TTO_TX does not satisfy the predetermined condition, the correction circuit 212 receives an instruction and accordingly generates a corrected TTO TTO′_1. In practice, the transmitting end may refer to a time interleaving depth TI of an interleaved video frame when generating a original TTO TTO_TX. Thus, in one embodiment, the correction circuit 212 uses the time interleaving depth TI of an interleaved video frame as the corrected TTO TTO′_1. Taking the DVB-T2 standard for instance, the time interleaving depth TI may be an integral multiple (e.g., three times) of a time length of one T2 video frame, or may be a fraction of an integer (e.g., one-third) of a time length of one T2 video frame. The correction circuit 212 may calculate the time interleaving depth TI of an interleaved video frame received by the signal receiving apparatus 200 according to information provided by the transmitting end. Associated calculation details are generally known to one person skilled in the art, and shall be omitted herein. The correction circuit 212 may store the above time interleaving depth TI in advance, or may obtain this information from a parsing result of the de-jitter buffer 207. When the verification result outputted from the comparing circuit 211C indicates that the original TTO TTO_TX does not satisfy the predetermined condition, the multiplexer 211D feeds the corrected TTO TTO′_1 into the addition circuit 212B, and the corrected TTO TTO′_1 is added with the average delay imp_delay to obtain the addition result Sum_1. Another possibility is that the correction circuit 212 stores the corrected output time TTO′_1 into the de-jitter buffer 207, and so the addition circuit 212B may fetch the corrected TTO TTO′_1 from the de-jitter buffer 207. In other words, when the interleaved video frame under verification is not the initial interleaved video frame but is a subsequent interleaved video frame, the TTO under verification is the corrected TTO TTO′ generated by the correction circuit 212.

In one embodiment, if the verification circuit 211 determines that the original TTO TTO_TX does not hold the predetermined condition true, the de-jitter buffer 207 is reset; that is, the de-jitter buffer 207 discards data associated with the initial interleaved video frame, and again starts receiving data associated with the next interleaved video frame. Further, the timing circuit 211A is reset to generate a counting result tto_Cnt for the next interleaved video frame. More specifically, the timing circuit 211A starts counting upon identifying the starting point of the next interleaved video frame, and outputs the counting result when the de-jitter buffer 207 acquires the original TTO TTO_TX of the interleaved video frame. After the timing circuit 211A outputs the counting result tto_Cnt (to be represented by tto_Cnt_1) of the next interleaved video frame, the comparison circuit 211C compares values of the counting result tto_Cnt_1 with the addition result Sum (i.e., the addition result of the corrected TTO TTO′_1 and imp_delay). If the addition result Sum_1 is greater than the counting result tto_Cnt_1, it means that the corrected TTO TTO′_1 holds the predetermined condition true, and this verification result drives the setting circuit 213 to set the time to output for the de-jitter buffer 207 to output the transport stream. For example, the setting circuit 213 can set, according to the addition result Sum_1, the time to output that causes the de-jitter buffer 207 to output the transport stream of multiple successive subsequent interleaved video frames.

If the verification result outputted by the comparison circuit 211C indicates that the corrected TTO TTO′_1 does not hold the predetermined condition true, the correction circuit 212 generates another corrected TTO TTO′_2 that is greater than the corrected TTO TTO′_1. In practice, the correction circuit 212 may slightly increase the corrected TTO each time till the corrected TTO satisfies the predetermined condition. In one embodiment, the correction circuit 212 calculates an allowed increment according to the capacity of the de-jitter buffer 207 and the output rate of the transport stream, and adds the allowed increment to the interleaving depth TI as the corrected TTO TTO′_2. For example, the correction circuit 212 may configure the allowed increment to correspond to a quarter of the capacity of the de-jitter buffer 207. Assuming that the capacity of the de-jitter buffer 207 is 2 MB and the output rate of the transport stream is 1 MB of data per 7/64 ms, so that the de-jitter buffer 207 outputs data of a quarter of its capacity every 7/128 ms. In this situation, 7/128 ms is the above allowed increment, and the corrected TTO TTO′_2 is the addition result of the time interleaving depth TI and 7/128 ms.

Similarly, the addition circuit 211B calculates an addition result Sum_2 of the corrected TTO TTO′_2 and the average delay imp_delay, and the comparison circuit 211C compares the addition result Sum_2 with a counting result tto_Cnt_2 corresponding to the next interleaved video frame to accordingly determine whether the corrected TTO TTO′_2 satisfies the predetermined condition. If the addition result Sum_2 is greater than the counting result tto_Cnt_2, the setting circuit 213 may set, according to the corrected TTO′_2, the time to output the transport stream for the de-jitter buffer 207. Conversely, if the addition result Sum_2 is smaller than the counting result tto_Cnt_2, the correction circuit 212 continues generating another corrected TTO TTO′_3 greater than the corrected TTO′_2, and so forth.

In the above embodiment, when the TTO under verification does not meet the predetermined condition, the de-jitter buffer 207 discards data associated with the interleaved video frame under verification, and the next interleaved video frame is selected as a new interleaved video frame under verification. In this situation, the corrected TTO TTO′ generated by the correction circuit 212 is for the use of the new interleaved video frame under verification, i.e., used as the TTO under verification of the new interleaved video frame under verification. For example, if the original TTO TTO_TX of the initial interleaved video frame does not meet the predetermined condition, the corrected TTO TTO′_1 generated by the correction circuit 212 is for the use of the new interleaved video frame under verification (i.e., the subsequent interleaved video frame but not the initial interleaved video frame). If the corrected TTO TTO′_1 meets the predetermined condition, the setting circuit 213 sets, according to the corrected TTO TTO′_1, the time to output the transport stream associated with the subsequent interleaved video frame for the de-jitter buffer 207.

In another embodiment, when the TTO under verification does not meet the predetermined condition, the de-jitter buffer 207 does not discard the data associated with the current interleaved video frame under verification. In this situation, the corrected TTO TTO′ generated by the correction circuit 212 is for the use of the current interleaved video frame that is under verification, and serves as a new TTO of this interleaved video frame. For example, if the original TTO TTO_TX of the initial interleaved video frame does not hold the predetermined condition true, the corrected TTO TTO′_1 generated by the correction circuit 212 is still for the use of the initial interleaved video frame, and serves as a new TTO under verification of the initial interleaved video frame. Only when the TTO under verification which meets the predetermined condition is found, the de-jitter buffer 207 can accordingly output the transport stream associated with the initial interleaved video frame.

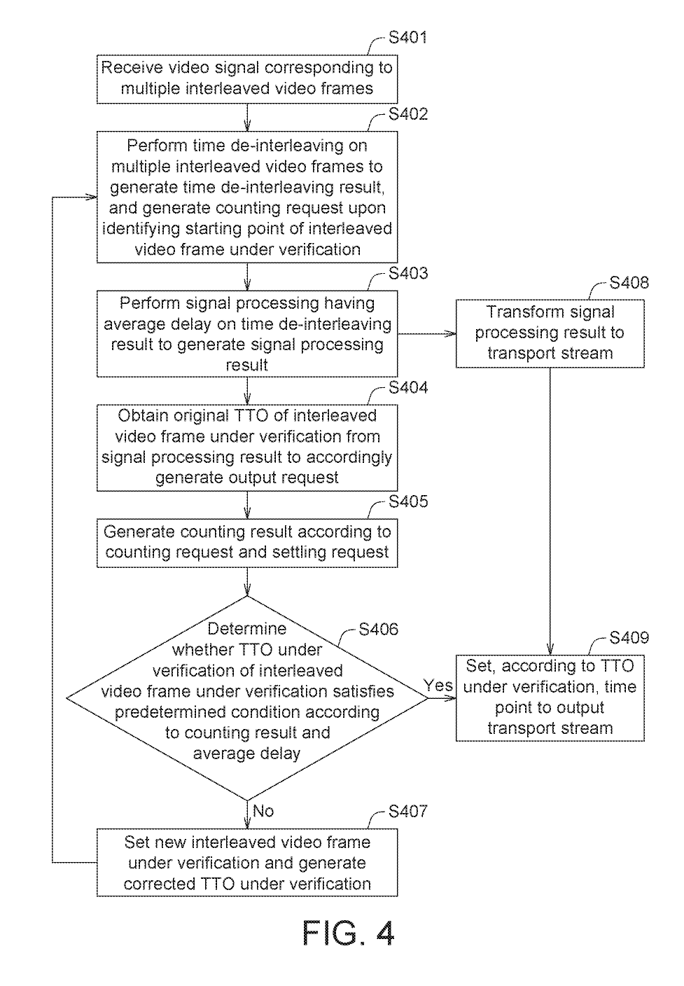

FIG. 4 shows a flowchart of a signal processing method applied to a DVB receiving end according to another embodiment of the present invention. In step S402, a video signal provided by a DVB transmitting end is provided, wherein the video signal corresponds to multiple interleaved video frames. In step S402, time de-interleaving is performed on the multiple interleaved video frames to generate a time de-interleaving result, and a counting request is generated upon identifying a starting point of an interleaved video frame under verification. In step S403, signal processing is performed on the time de-interleaving result to generate a signal processing result, wherein the signal processing has an average delay. In step S404, an original TTO associated with the interleaved video frame under verification is obtained from the signal processing result to accordingly generate an outputrequest. In step S405, a counting result is generated according to the timing result and the output result generated in step S404. In step S406, it is determined, according to the counting result and the average delay of the signal processing, whether the TTO under verification of the interleaved video frame under verification satisfies a predetermined condition. If the determination result of step S406 is negative, step S407 is performed to set a new interleaved video frame under verification, and a corrected TTO under verification is generated. After step S407, step S402 and subsequent steps are iterated. On the other hand, step S403 is followed by step S408, in which the signal processing result is converted to a transport stream. If the determination result of step S406 is affirmative, step S409 is performed to set, according to the TTO under verification, a time to output the transport stream generated in step S408.

One person skilled in the art can appreciate that, operation variations in the description associated with the signal receiving apparatus 200 are applicable to the signal processing method in FIG. 4, and are omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A signal receiving apparatus, for receiving a video signal provided by a Digital Video Broadcasting (DVB) transmitting end, the video signal corresponding to a plurality of interleaved video frames, the signal receiving apparatus comprising:
a time de-interleaver, performing time de-interleaving on the plurality of interleaved video frames to generate a time de-interleaving result, and generating a counting request upon identifying a starting point of an interleaved video frame under verification;
a signal processing circuit, performing signal processing on the time de-interleaving result to generate a signal processing result, wherein the signal processing has an average delay;
a de-jitter buffer, obtaining an original time-to-output (TTO) of the interleaved video frame under verification from the signal processing result, accordingly generating an output request, and transforming the signal processing result into a transport stream;
a verification circuit, generating a counting result according to the counting request and the output request, and determining, according to the counting result and the average delay, whether a TTO under verification of the interleaved video frame under verification satisfies a predetermined condition;
a correction circuit, if the TTO under verification does not satisfy the predetermined condition, generating a corrected TTO under verification, and requesting the verification circuit to verify whether the corrected TTO under verification satisfies the predetermined condition; and
a setting circuit, if the TTO under verification satisfies the predetermined condition, the setting circuit setting, according to the TTO under verification, a time to output the transport stream for the de-jitter buffer.

2. The signal receiving apparatus according to claim 1, wherein the verification circuit comprises:
a counting circuit, starting to count according to the counting request, and outputting the counting result according to the output request;
an addition circuit, calculating an addition result of the TTO under verification and the average delay; and
a comparison circuit, comparing the addition result with the counting result, wherein when the addition result is greater than the counting result, it is indicated that the TTO under verification satisfies the predetermined condition.

3. The signal receiving apparatus according to claim 2, wherein if the comparison circuit determines that the TTO under verification satisfies the predetermined condition, the setting circuit causes the de-jitter buffer to output the transport stream when a working time length accumulated by the counting circuit is equal to the addition result.

4. The signal receiving apparatus according to claim 1, wherein the correction circuit uses a time interleaving depth of the interleaved video frame under verification as the corrected TTO under verification.

5. The signal receiving apparatus according to claim 4, wherein if the verification circuit determines that the corrected TTO under verification does not satisfy the predetermined condition, the correction circuit calculates an allowed increment according to a capacity of the de-jitter buffer and a transport stream output rate, adds the allowed increment to the time interleaving depth to generate another corrected TTO under verification, and requests the verification circuit to verify whether the another corrected TTO under verification satisfies the predetermined condition.

6. The signal receiving apparatus according to claim 1, wherein the corrected TTO under verification is generated for a subsequent interleaved video frame of the plurality of interleaved video frames; if the verification circuit determines that the corrected TTO under verification satisfies the predetermined condition, the setting circuit sets, according to the corrected TTO under verification, the time to output the transport stream for the de-jitter buffer.

7. The signal receiving apparatus according to claim 1, wherein the corrected TTO under verification is generated for the interleaved video frame under verification; if the verification circuit determines that the corrected TTO under verification satisfies the predetermined condition, the setting circuit sets, according to the corrected TTO under verification, the time to output the transport stream for the de-jitter buffer.

8. A signal processing method, applied to a Digital Video Broadcasting (DVB) receiving end, comprising:
a) receiving a video signal provided by a DVB transmitting end, wherein the video signal corresponds to a plurality of interleaved video frames;
b) performing time de-interleaving on the plurality of interleaved video frames to generate a time de-interleaving result, and generating a counting request upon identifying a starting point of an interleaved video frame under verification;
c) performing signal processing on the time de-interleaving result to generate a signal processing result, wherein the signal processing has an average delay;
d) acquiring an original time-to-output (TTO) of the interleaved video frame under verification from the signal processing result, and accordingly generating an output request;
e) transforming the signal processing result to a transport stream;
f) generating a counting result according to the counting request and the output result, and determine whether a TTO under verification of the interleaved video frame under verification satisfies a predetermined condition according to the timing result and the average delay;
g) if the TTO under verification does not satisfy the predetermined condition, generating a corrected TTO under verification, and verifying whether the corrected TTO under verification satisfies the predetermined condition; and
h) if the TTO under verification satisfies the predetermined condition, setting, according to the TTO under verification, a time to output the transport stream.

9. The signal processing method according to claim 8, wherein step (f) comprises:
calculating an addition result of the TTO under verification and the average delay;
comparing the addition result with the counting result; and
if the addition result is greater than the counting result, determining that the predetermined condition is met.

10. The signal processing method according to claim 9, comprising:
starting to count according to the counting request, and accumulating a working time length; and
if it is determined that the TTO under verification satisfies the predetermined condition, outputting the transport stream when the working time length is equal to the addition result.

11. The signal processing method according to claim 8, wherein step (g) comprises using a time interleaving depth of the interleaved video frame under verification as the corrected TTO under verification.

12. The signal processing method according to claim 11, further comprising:
if it is determined in step (g) that the corrected TTO under verification does not satisfy the predetermined condition, calculating an allowed increment according to a buffer capacity and a transport stream output rate;
adding the allowed increment to the time interleaving depth to generate another corrected TTO under verification; and
verifying whether the another corrected TTO under verification satisfies the predetermined condition.

13. The signal processing method according to claim 8, wherein the corrected TTO under verification is generated for a subsequent interleaved video frame in the plurality of interleaved video frames; if it is determined in step (g) that the corrected TTO under verification satisfies the predetermined condition, step (h) sets, according to the corrected TTO under verification, the time to output the transport stream.

14. The signal processing method according to claim 8, wherein the corrected TTO under verification is generated for the interleaved video frame under verification; if it is determined in step (g) that the corrected TTO under verification satisfies the predetermined condition, step (h) sets, according to the corrected TTO under verification, the time to output the transport stream.
